(19) United States
(12) Patent Application Publication
(10) Pub. No.: US 2013/0313788 A1
(43) Pub. Date: Nov. 28, 2013

(54) SPIRAL WOUND GASKET

(71) Applicant: Teadit N.A., Inc., Pasadena, TX (US)

(72) Inventors: Jose Carlos Carvalho Veiga, Rio de Janeiro (BR); Nelson Kavanagh, Campinas (BR)

(73) Assignee: Teadit N.A., Inc., Pasadena, TX (US)

(21) Appl. No.: 13/901,180

(22) Filed: May 23, 2013

Related U.S. Application Data
(60) Provisional application No. 61/678,446, filed on Aug. 1, 2012.

(30) Foreign Application Priority Data
May 23, 2012 (BR) 2020120123113

(51) Int. Cl. F16L 23/18

(52) U.S. Cl. CPC F16L 23/18
USPC 277/610

(57) ABSTRACT

A spiral wound gasket for sealing flanged joints. The spiral wound gasket has improved sealability with a spiral sealing element that includes a metallic strip and a relatively soft filler material, wherein the axial width of the relatively soft filler material is greater than the axial width of the metallic strip. The spiral wound gasket also has improved sealability with a controlled gasket density and in which the metallic strip has a uniform and symmetrical “V” or “W” cross-sectional shape.

### CROSS-REFERENCE TO RELATED APPLICATIONS

The present application claims the benefit of the filing date of U.S. Patent Application No. 61/678,446 filed Aug. 1, 2012, the entire disclosure of which is hereby incorporated herein by reference.

The present application claims priority to Brazilian Patent Application No. BR 20 2012 012311 3 filed May 23, 2012, the entire disclosure of which is hereby incorporated herein by reference.

### FIELD OF THE INVENTION

The present invention relates to a spiral wound gasket used for sealing flanged joints. More particularly, the present invention relates to a spiral wound gasket with improved sealability having a spiral sealing element that includes a metallic strip and a relatively soft filler material, wherein the axial width of the relatively soft filler material is greater than the axial width of the metallic strip. The present invention also relates to a spiral wound gasket with improved sealability having a controlled gasket density and in which the metallic strip has a uniform and symmetrical “V” or “W” cross-sectional shape.

### BACKGROUND

Spiral wound gaskets are used within many industries, including those that process liquids, gases and gaseous hydrocarbons, to seal flange joints.

Conventional spiral wound gaskets are shown in FIG. 1 and include a spiral sealing element 10 made of alternating layers of a metallic strip 12 and a strip of a relatively soft filler material 14 spirally wound around a central axis. The construction of the spiral sealing element 10 typically begins with a base structure that includes initial windings of the metallic strip 12 for three contiguous rotations, without the addition of any relatively soft filler material 14. The initial windings are spot welded together at regular intervals, typically every 76 mm along the perimeter of the metallic strip 12, to insure the integrity of the base structure. Following the initial windings, the construction of the spiral sealing element 10 then introduces layers of the relatively soft filler material 14 in between each layer of the metallic strip 12. When the desired gasket width or outside diameter of the spiral sealing element 10 is reached, the construction of the spiral sealing element 10 proceeds to the final windings of the metallic strip 12 for three contiguous rotations, without the addition of any relatively soft filler material 14, to form the outer circumference of the spiral sealing element 10. These final windings are welded together in the same manner as the initial windings described above.

According to the standards set forth in the American Society of Mechanical Engineers (ASME) publication B16.20-2007 Metallic Gaskets for Pipe Flanges (hereinafter referred to as ASME B16.20), the thickness of the metallic strip 12 used in the construction of spiral wound gaskets must be within the range of from 0.15 mm to 0.23 mm. The thickness of the relatively soft filler material 14 may vary, however, at the discretion of the gasket manufacturer. Consequently, in conventional spiral wound gaskets, the relatively soft filler material 14 has a significantly larger thickness compared to the metallic strip 12, so as to reduce manufacturing costs. As a result, the density, defined as the number of windings of metal and filler per millimeter of gasket thickness, of such conventional spiral wound gaskets, is concomitantly reduced. For instance, typical conventional spiral wound gaskets have a density ranging from about 0.80 windings per millimeter (w/mm) to about 1.35 w/mm.

Also, in conventional spiral wound gaskets such as those shown in FIGS. 1 and 2, the relatively soft filler material 14 has the same axial width as the metallic strip 12. According to the standards set forth in ASME B16.20, the typical axial width of the metallic strip 12 and the relatively soft filler material 14 ranges from about 4.31 mm to about 4.57 mm.

In addition to the spiral sealing element 10, conventional spiral wound gaskets may include an outer ring 16 assembled around the outer circumference of the spiral sealing element 10. Typically, the outer ring 16 includes a groove 18 on its inner edge and the outer surface of the spiral sealing element 10 has an apex or nose 20 which fits in the groove 18. The outer ring 16 helps to restrict the maximum compression of the spiral wound gasket, increases the radial strength of the gasket, and aids in centering the gasket within the bolt ring of the flange joint.

Further, conventional spiral wound gaskets may also include an inner ring 22 located within the inner perimeter of the spiral sealing element 10, which helps to prevent inward extrusion of the spiral wound gasket as well as to protect the spiral sealing element 10 from contamination or turbulence from the flow of fluid through the pipe.

As shown in FIGS. 3 and 4, a spiral wound gasket 24 is typically placed between the flanges 26 installed on the ends of pipes 28. The flanges are held together by bolts 30 spaced around the circumference of the flanges 26. The bolts 30 help to center the gasket 24 placed between the flanges 26.

In flange joints using conventional spiral wound gaskets, the metallic strip 12 engages with the inner faces of the flanges 26. The pressure or seating stress applied through the flanges 26 axially compresses the metallic strip 12, typically down to the axial width of the outer ring 16. Additionally, the pressure or seating stress applied through the flanges 26 axially compresses and increases the density of the relatively soft filler material 14. Together, these actions create a seal between the flanges 26.

Typically, as discussed above, in accordance with ASME B16.20, conventional spiral wound gaskets have an axial width of approximately 4.31 to 4.57 mm when in an uncompressed form, and are designed to be compressed axially to a width of approximately 2.97 to 3.33 mm, which is the axial width of a typical outer ring 16. Depending on the compressibility of the relatively soft filler material 14, however, the gasket may reach full compression before the seating stress applied to the gasket is sufficient to provide adequate sealing. In these cases, small leaks of fluid or gas traveling through the pipes 28, called fugitive emissions, may occur.

Environmental regulations mandate increasingly low fugitive emissions values, for example in oil or gas transport pipes. Some environmental protection organizations mandate a fugitive emissions value, with respect to the emission of volatile organic compounds, of less than 500 parts per million in volume (ppmV). Other, more rigorous standards require a fugitive emissions value of less than 100 ppmV.

FIGS. 5 and 6 show the results of fugitive emissions tests conducted with conventional spiral wound gaskets having a density of 0.869 w/mm in which the metallic strip has an axial width that is greater than the axial width of the guide ring, the metallic strip and the relatively soft filler material have the same axial width and the metallic strip has a uniform and symmetrical “V” cross-sectional shape. The fugitive emissions tests were conducted by measuring the leakage of methane gas using a Thermo Fisher Scientific Inc. model TVA-1000 toxic vapor analyzer. FIGS. 5 and 6 clearly demonstrate that such conventional spiral wound gaskets exhibit fugitive emissions values of less than 100 ppmV of methane gas only at a very high seating stress, above, for example, 140 MPa (megapascals) (FIG. 6), or 170 MPa (FIG. 5). This required level of pressure is too high for most flanges of various diameters to endure without structural damage. For example, according to the standards set forth in ASME B16.5, a flange that is manufactured for 150 pressure class lines and 3-inch nominal diameters can withstand pressures up to a maximum of 132 MPa. As shown in FIGS. 5 and 6, the use of conventional spiral wound gaskets at a maximum pressure of 132 MPa would not yield fugitive emissions values that are in compliance with applicable environmental regulations.

Additionally, the low density of conventional spiral wound gaskets, which typically ranges from about 0.8 w/mm to about 1.35 w/mm, reduces sealing capability and increases leakage. For instance, FIG. 7 shows the results of fugitive emissions tests conducted with conventional spiral wound gaskets having densities of 0.869 w/mm, 0.994 w/mm and 1.132 w/mm, in which the metallic strip has an axial width that is greater than the axial width of the guide ring, the metallic strip and the relatively soft filler material have the same axial width and the metallic strip has a uniform and symmetrical “V” cross-sectional shape. The fugitive emissions tests were conducted by measuring the leakage of methane gas using a Thermo Fisher Scientific Inc. model TVA-1000 toxic vapor analyzer. FIG. 7 clearly demonstrates that at a particular seating stress, the lower the density, the greater the leakage.

Further, as shown in FIG. 8, the low density of conventional spiral wound gaskets allows the sealing surfaces 32 of the flanges 26 to come into contact with the outer ring 16 under pressure. As shown in FIG. 8, when the sealing surfaces 32 of the flanges contact the outer ring 16, the sealing surfaces 32 of the flanges 26 rotate, which reduces the seating stress applied to the inner diameter area 34 of the spiral wound gasket, thereby reducing the sealing capability of the spiral wound gasket.

Therefore, there is a need for a spiral wound gasket having improved sealing capability at lower seating stress and that sufficiently reduces fugitive emissions.

### BRIEF DESCRIPTION OF THE DRAWINGS

FIG. 1 illustrates a cross-sectional view of a conventional spiral wound gasket.

FIG. 2 illustrates a cross-sectional view of a conventional spiral wound gasket demonstrating that the width of the relatively soft filler material is the same as the width of the metallic strips.

FIG. 3 illustrates a section of a pipe with a conventional spiral wound gasket placed between two unjoined flanges.

FIG. 4 illustrates a pipe section in which two pipes, each with a corresponding flange are joined together by bolts.

FIG. 5 illustrates leakage and seating stress measurements of a typical low density conventional spiral wound gasket in which the metallic strip has an axial width that is greater than the axial width of the guide ring, and the metallic strip and the relatively soft filler material have the same axial width under a range of pressures.

FIG. 6 illustrates leakage and seating stress measurements of a conventional low density spiral wound gasket in which the metallic strip has an axial width that is greater than the axial width of the guide ring, and the metallic strip and the relatively soft filler material have the same axial width.

FIG. 7 illustrates leakage and seating stress measurements of various conventional low density spiral wound gaskets in which the metallic strip has an axial width that is greater than the axial width of the guide ring, and the metallic strip and the relatively soft filler material have the same axial width.

FIG. 8 illustrates a section of a conventional spiral wound gasket engaged with two flanges, wherein the sealing surfaces of the flanges are in contact with the outer ring of the gasket.

FIG. 9 illustrates a cross-sectional view of a spiral wound gasket according to the present invention in which the axial width of the metallic strip is greater than the axial width of the guide ring and the axial width of the relatively soft filler material is greater than the axial width of the metallic strip.

FIG. 10 illustrates a spiral wound gasket according to the present invention.

FIG. 11 illustrates a cross-sectional view of a spiral wound gasket according to the present invention.

FIG. 12 illustrates an exploded view of a spiral wound gasket according to the present invention.

FIG. 13 illustrates comparative leakage and seating stress measurements of a conventional low density spiral wound gasket in which the axial width of the metallic strip is greater than the axial width of the guide ring and the relatively soft filler material has the same axial width as the metallic strip, and a spiral wound gasket according to the present invention in which the axial width of the metallic strip is greater than the axial width of the guide ring and the axial width of the relatively soft filler material is greater than the axial width of the metallic strip.

FIG. 14 illustrates comparative leakage and seating stress measurements of a conventional low density spiral wound gasket in which the axial width of the metallic strip is greater than the axial width of the guide ring and the relatively soft filler material has the same axial width as the metallic strip, and low density spiral wound gaskets in which the axial width of the metallic strip is greater than the axial width of the guide ring and the axial width of the relatively soft filler material is greater than the axial width of the metallic strip.

FIG. 15 illustrates comparative leakage and seating stress measurements of spiral wound gaskets of various densities according to the present invention in which the axial width of the metallic strip is greater than the axial width of the guide ring and the axial width of the relatively soft filler material is greater than the axial width of the metallic strip.

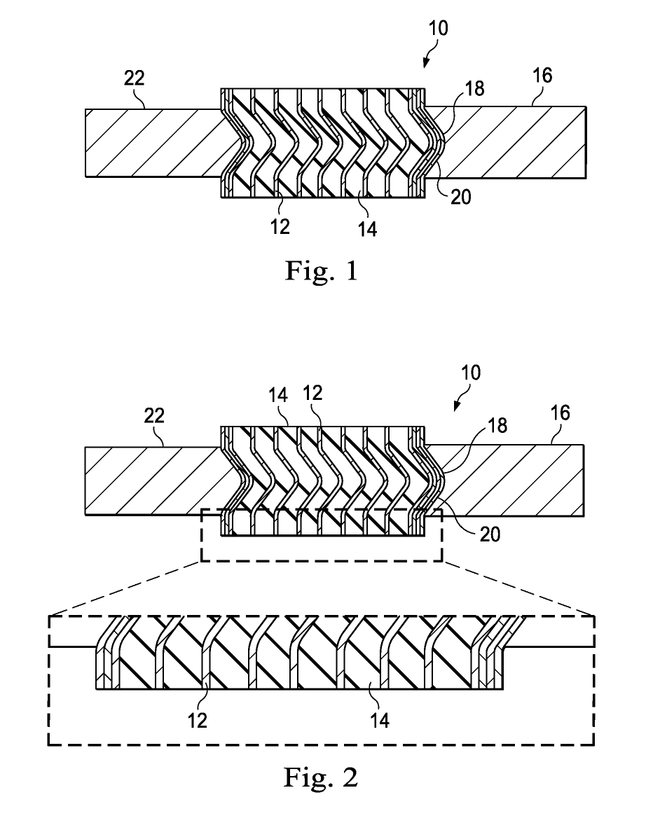

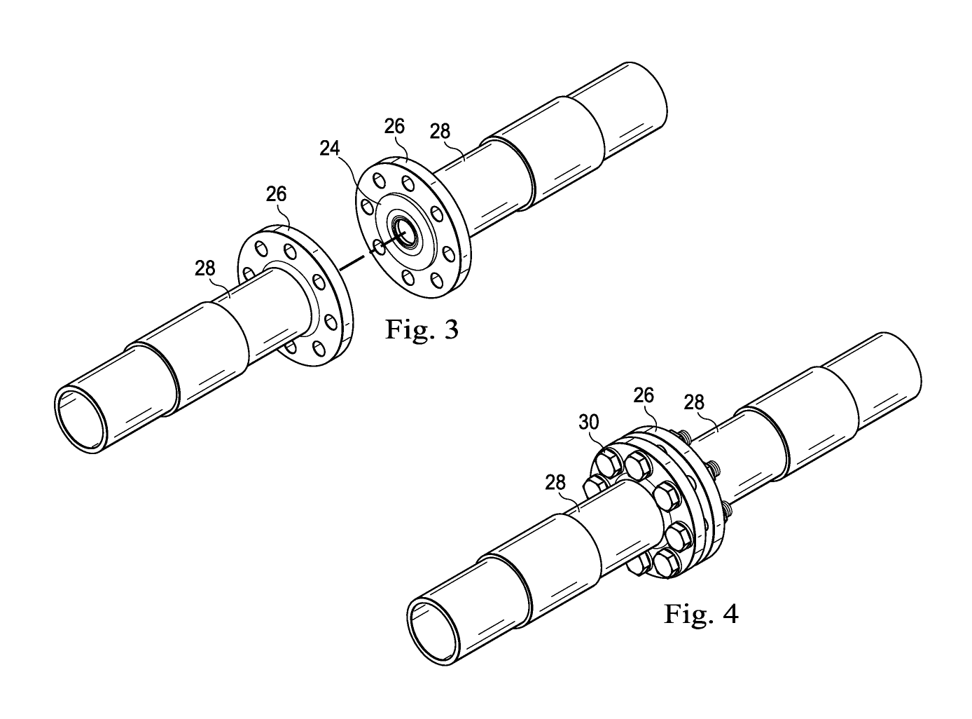

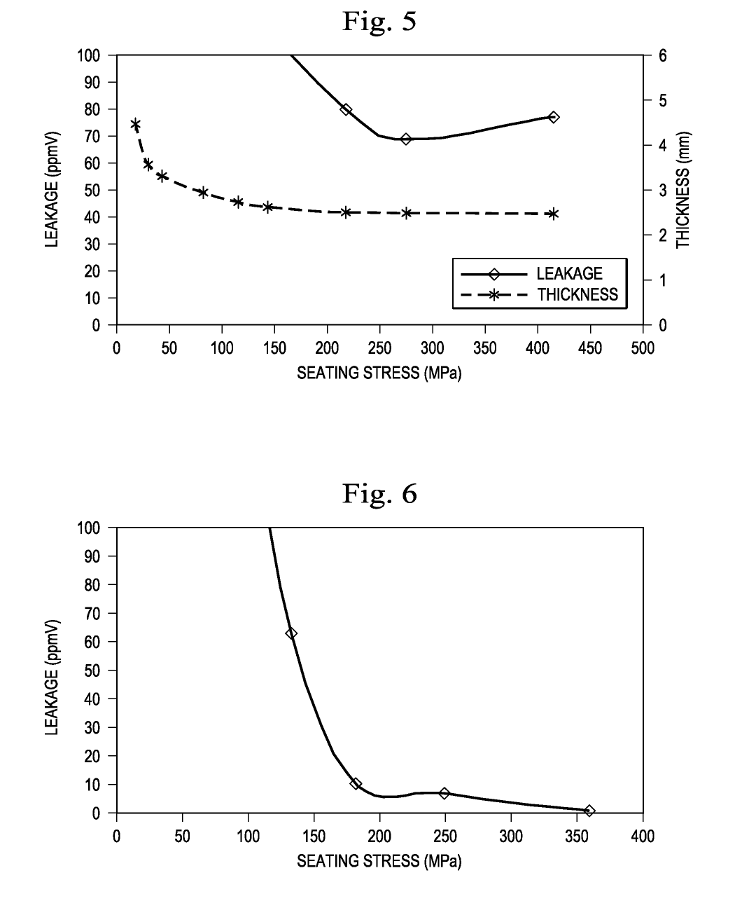

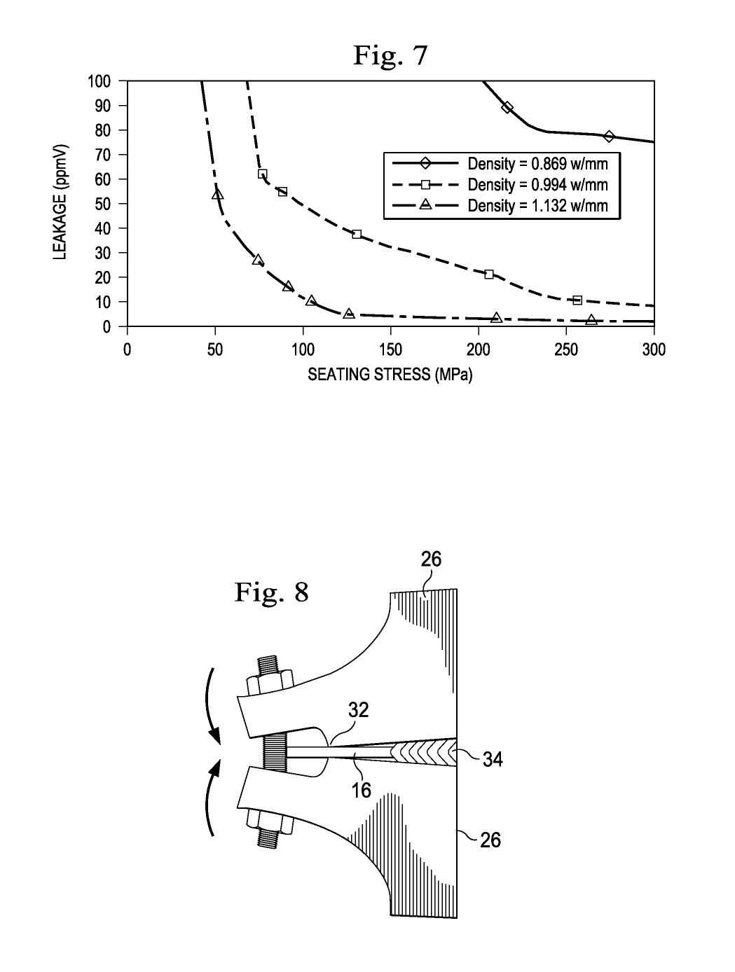

### DETAILED DESCRIPTION

Reference is now made to the drawings that illustrate certain embodiments of the present invention. It should be understood that the present invention is not limited to the embodiments shown in the drawings.

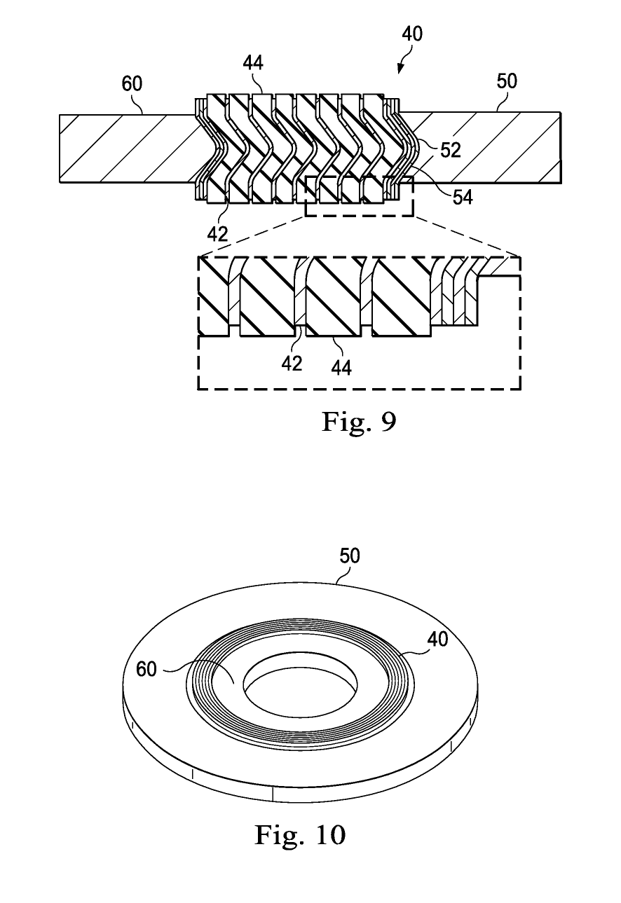

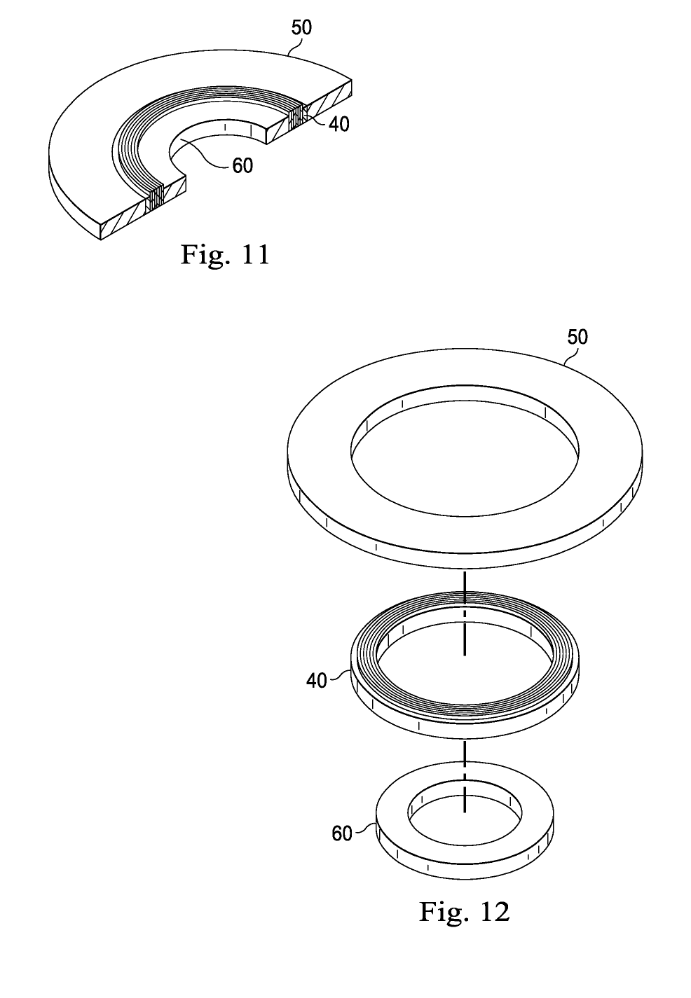

Referring to FIGS. 9-12, the apparatus of the present invention provides a spiral wound gasket with improved sealing capabilities for use in the sealing of flange joints. According to an embodiment of the present invention, a spiral sealing element 40 is constructed using the conventional winding procedure described above. As shown in FIG. 9, the spiral sealing element 40 includes a metallic strip 42 and a relatively soft filler material 44. In certain embodiments, the metallic strip 42 has a thickness of from about 0.15 mm to about 0.23 mm. In some embodiments, the metallic strip 42 and the relatively soft filler material 44 have a “V” or “W” shape, as shown in FIG. 9, which facilitates axial compression of the spiral sealing element 40 under pressure. In certain embodiments, the “V” or “W” shape of the metallic strip 42 is uniform and symmetrical.

In some embodiments of the present invention, the metallic strip 42 used in the construction of the spiral sealing element 40, is made of at least one of any number of suitable metals known by those of ordinary skill in the art, including carbon-rich or stainless steel, titanium, nickel, or nickel alloy.

In some embodiments of the present invention, the relatively soft filler material 44 used in the construction of the spiral sealing element 40, is made of any of a number of relatively soft filler materials known by those of ordinary skill in the art that are capable of deforming when the spiral wound gasket is compressed between the pipe flanges that define the flange joint, including, for example, fluorocarbon resin, such as polytetrafluoroethylene (“PTFE”), graphite, including exfoliated graphite, flexible graphite and oxidation inhibited graphite, ceramics, and aluminum.

The choice of the particular type of metal or relatively soft filler material used depends on the environment in which the spiral wound gasket according to the present invention is to be used. According to some embodiments of the present invention, the spiral wound gasket may be used in environments having operating temperatures of up to 850° F.

According to some embodiments of the present invention as shown in FIGS. 9-12, the spiral wound gasket includes an outer ring 50 assembled around the outer circumference of the spiral sealing element 40. The outer ring 50 may be in the form of a metal annulus, and may be made of at least one suitable material known by those of ordinary skill in the art, such as carbon-rich or stainless steel, titanium, nickel, or nickel alloy. In one embodiment, as shown in FIG. 9, the outer ring 50 includes a groove 52 on its inner edge and the outer surface of the spiral sealing element 40 has an apex or nose 54 that fits within the groove 52. In certain embodiments of the present invention, the outer ring 50 has an axial width of from about 2.97 mm to about 3.33 mm.

According to some embodiments of the present invention as shown in FIGS. 9-12, the spiral wound gasket includes an inner ring 60 located within the inner perimeter of the spiral sealing element 40. The inner ring 60 may be in the form of a metal annulus, and may be made of at least one suitable material known by those of ordinary skill in the art, such as carbon-rich or stainless steel, titanium, nickel, or nickel alloy.

According to an embodiment of the present invention, as shown in FIG. 9, the metallic strip protrudes axially beyond the outer ring 50 and the inner ring 60, and, the relatively soft filler material 44 protrudes axially beyond the metallic strip 42 on either or both sides of the spiral sealing element 40. The axial protrusion of the relatively soft filler material 44 allows the compressible relatively soft filler material 44 to come in contact with the flanges of the pipes to be sealed before the metallic strip 42 as seating stress is applied. This allows the relatively soft filler material 44 to fill in any irregularities on the faces of the flanges, thereby improving the sealing capabilities of the spiral wound gasket. Also, the axial width of the relatively soft filler material 44, and the corresponding amount by which it axially protrudes beyond the metallic strip 42 on either or both sides of the spiral sealing element 40, can be chosen based on the environment in which the spiral wound gasket including the relatively soft filler material 44 is to be used and any applicable environmental regulations.

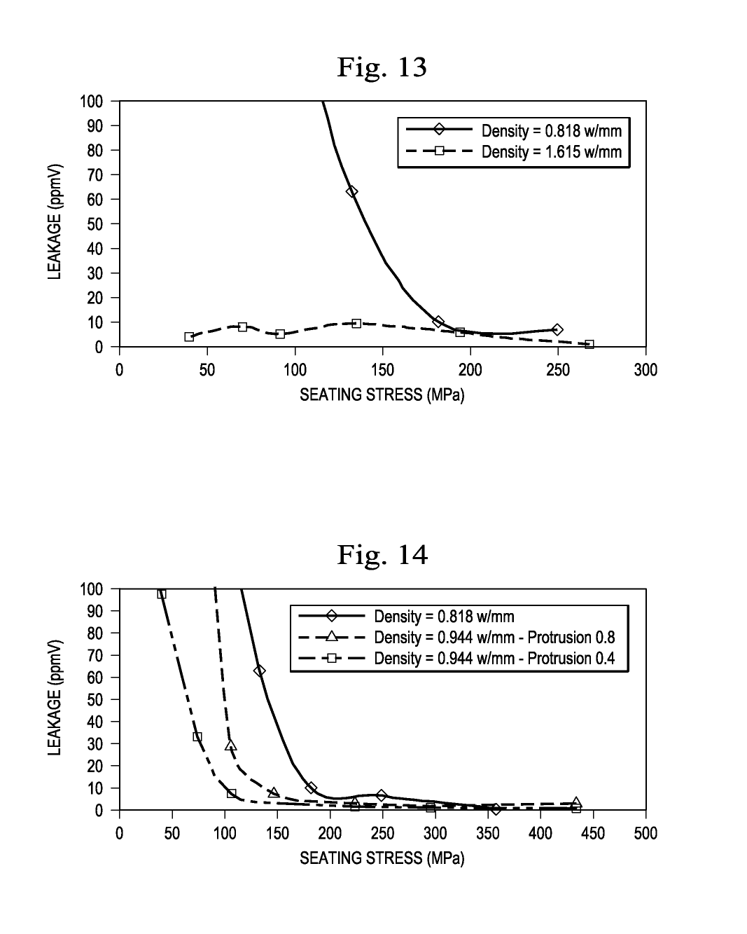

FIG. 13 shows the results of fugitive emissions tests conducted with a conventional spiral wound gasket having a density of 0.818 w/mm in which the metallic strip has an axial width that is greater than the axial width of the guide ring, the metallic strip and the relatively soft filler material have the same axial width and the metallic strip has a uniform and symmetrical “V” cross-sectional shape, and a spiral wound gasket according to the present invention having a density of 1.615 w/mm in which the metallic strip has an axial width that is greater than the axial width of the guide ring, the relatively soft filler material has an axial width that is greater than the axial width of the metallic strip and protrudes for a distance of between 0.2 mm and 1.0 mm from both sides of the metallic strip, and the metallic strip has a uniform and symmetrical “V” cross-sectional shape. The fugitive emissions tests were conducted by measuring the leakage of methane gas using a Thermo Fisher Scientific Inc. model TVA-1000 toxic vapor analyzer. FIG. 13 clearly demonstrates that the spiral wound gasket according to the present invention exhibits improved fugitive emission values as compared to the conventional low density spiral wound gasket in which the relatively soft filler material has the same axial width as the metallic strip. Specifically, the spiral wound gasket according to the present invention exhibits a fugitive emissions value of less than 10 ppmV of methane gas at a seating stress of as low as 40 MPa, whereas the conventional spiral wound gasket requires a seating stress of at least 190 MPa to achieve such a low fugitive emissions value.

FIG. 14 shows the results of fugitive emissions tests conducted with a conventional spiral wound gasket having a density of 0.818 w/mm in which the metallic strip has an axial width that is greater than the axial width of the guide ring, the metallic strip and the relatively soft filler material have the same axial width and the metallic strip has a uniform and symmetrical “V” cross-sectional shape, and spiral wound gaskets having a density of 0.994 w/mm in which the metallic strip has an axial width that is greater than the axial width of the guide ring, the soft filler material has an axial width that is greater than the axial width of the metallic strip and protrudes for a distance of about 0.4 mm or about 0.8 mm from both sides of the metallic strip, and the metallic strip has a uniform and symmetrical “V” cross-sectional shape. The fugitive emissions tests were conducted by measuring the leakage of methane gas using a Thermo Fisher Scientific Inc. model TVA-1000 toxic vapor analyzer. As can be seen in FIG. 14, a low density spiral wound gasket in which the relatively soft filler material has an axial width that is greater than the axial width of the metallic strip and protrudes axially from both sides of the metallic strip for a distance about 0.4 mm yields fugitive emissions values of less than 100 ppmV of methane gas at a seating stress of approximately 50 MPa and less than 10 ppmV of methane gas at a seating stress of approximately 105 MPa. Also as shown in FIG. 14, a low density spiral wound gasket in which the relatively soft filler material has an axial width that is greater than the axial width of the metallic strip and protrudes axially from both sides of the metallic strip for a distance about 0.8 mm yields fugitive emissions values of less than 100 ppmV of methane gas at a seating stress of approximately 100 MPa and less than 10 ppmV of methane gas at a seating stress of approximately 145 MPa. The results shown in FIG. 14 clearly demonstrate that the low density spiral wound gaskets in which the relatively soft filler material has an axial width that is greater than the axial width of the metallic strip exhibit improved fugitive emission values as compared to the conventional low density spiral wound gasket in which the relatively soft filler material has the same axial width as the metallic strip, but that they exhibit fugitive emissions values of less than 10 ppmV of methane gas only at unacceptably high seating stress values of 105 MPa and 145 MPa.

The axial width of the relatively soft filler material 44 used in certain embodiments of the present invention can be adjusted to account for the maximum seating stress allowed for the particular flanges used and the surrounding environment. According to one embodiment, the relatively soft filler material 44 protrudes axially from the metallic strip 42 by a distance of at least 0.2 mm on either or both sides of the spiral sealing element 40. According to another embodiment, the relatively soft filler material 44 protrudes axially from the metallic strip 42 by a distance of at least 0.3 mm on either or both sides of the spiral sealing element 40. According to another embodiment, the relatively soft filler material 44 protrudes axially from the metallic strip 42 by a distance of from about 0.2 mm to less than about 1.0 mm on either or both sides of the spiral sealing element 40. According to another embodiment, the relatively soft filler material 44 protrudes axially from the metallic strip 42 by a distance of from about 0.3 mm to less than about 1.0 mm on either or both sides of the spiral sealing element 40. According to another embodiment, the relatively soft filler material 44 protrudes axially from the metallic strip 42 by a distance of from about 0.4 mm to about 0.8 mm on either or both sides of the spiral sealing element 40.

In certain embodiments of the spiral wound gasket according to the present invention, the gasket has a density of from about 1.4 w/mm to about 1.90 w/mm. Such a gasket density renders the gasket strong enough to withstand the required seating stresses such that the surface of the flanges do not contact the outer ring 50.

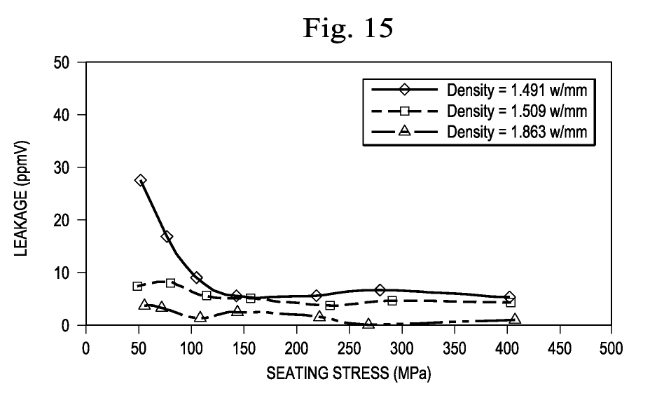

FIG. 15 shows the results of fugitive emissions tests conducted with spiral wound gaskets according to the present invention having densities of 1.491 w/mm, 1.509 w/mm and 1.863 w/mm in which the metallic strip has an axial width that is greater than the axial width of the guide ring, the relatively soft filler material has an axial width that is greater than the axial width of the metallic strip and protrudes from the metallic strip by a distance of from more than 0.2 mm up to 1.0 mm, and the metallic strip has a uniform and symmetrical “V” cross-sectional shape. The fugitive emissions tests were conducted by measuring the leakage of methane gas using a Thermo Fisher Scientific Inc. model TVA-1000 toxic vapor analyzer. FIG. 15 clearly demonstrates that spiral wound gaskets manufactured in accordance with the present invention, having densities of 1.491 w/mm, 1.509 w/mm and 1.863 w/mm, in which the relatively soft filler material has an axial width that is greater than the axial width of the metallic strip and protrudes from the metallic strip by a distance of from more than 0.2 mm up to 1.0 mm, yield fugitive emissions values of about 10 ppmV of methane gas at seating stresses below 100 MPa and fugitive emissions values of less than 30 ppmV of methane gas at seating stresses below 50 MPa. For example, as illustrated in FIG. 15, a spiral wound gasket according to the present invention with a density of 1.491 w/mm yields a fugitive emissions value of about 10 ppmV of methane gas or less at a seating stress of about 100 MPa or less. A spiral wound gasket according to the present invention with a density of 1.509 w/mm yields a fugitive emissions value of about 10 ppmV of methane gas or less at a seating stress of about 50 MPa or less. A spiral wound gasket according to the present invention with a density of 1.863 w/mm yields a fugitive emissions value of about 5 ppmV of methane gas or less at a seating stress of about 50 MPa or less.

In some embodiments, the spiral wound gasket of the present invention yields a fugitive emissions value of less than 10 ppmV of methane gas at a seating stress of less than 50 MPa. In other embodiments, the spiral wound gasket of the present invention yields a fugitive emissions value of less than 100 ppmV of methane gas at a seating stress of less than 100 MPa. In yet other embodiments, the spiral wound gasket of the present invention yields a fugitive emissions value of less than 30 ppmV of methane gas at a seating stress of less than 50 MPa.

In certain embodiments, the spiral wound gasket has a circular shape. In other embodiments, the spiral wound gasket has an oval shape. In still other embodiments, the spiral wound gasket has any suitable shape known by those of ordinary skill in the art.

It is understood that variations may be made in the foregoing without departing from the scope of the disclosure.

In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes and/or procedures may be merged into one or more steps, processes and/or procedures. In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those of ordinary skill in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, any means-plus-function clauses are intended to cover the structures described herein as performing the recited function and not only structural equivalents, but also equivalent structures.

What is claimed:

1. Apparatus for sealing flange joints, comprising:
a spiral sealing element and a guide ring having an axial width, the spiral sealing element comprising:
(a) a metallic strip, the metallic strip having a uniform and symmetrical V-shaped or W-shaped cross-section and having an axial width that is greater that the axial width of the guide ring; and
(b) a relatively soft filler material, the relatively soft filler material having an axial width that is greater than the axial width of the metallic strip such that the filler material protrudes axially beyond the metallic strip for a distance of from 0.3 mm to 1.0 mm;
wherein the metallic strip and relatively soft filler material are spirally wound upon each other around a central axis in alternating layers;
wherein the spiral sealing element has a density of from 1.4 to 1.9 windings per millimeter (w/mm); and
wherein the apparatus yields fugitive emissions of less than 50 ppmV of methane gas at a seating stress of less than 100 MPa.

2. The apparatus of claim 1, wherein the apparatus yields fugitive emissions of less than 20 ppmV of methane gas at a seating stress of less than 100 MPa.

3. The apparatus of claim 1, wherein the apparatus yields fugitive emissions of less than 10 ppmV of methane gas at a seating stress of less than 100 MPa.

4. The apparatus of claim 1, wherein the apparatus yields fugitive emissions of less than 10 ppmV of methane gas at a seating stress of less than 50 MPa.

5. An apparatus for sealing flange joints, comprising:
a spiral sealing element;
wherein:
the spiral sealing element comprises a metallic strip, and
a relatively soft filler material, wherein:
the metallic strip and relatively soft filler material are spirally wound upon each other around a central axis in alternating layers; and
the relatively soft filler material protrudes axially beyond the metallic strip.

6. The apparatus of claim 5, wherein the relatively soft filler material protrudes axially at least 0.2 mm beyond the metallic strip.

7. The apparatus of claim 5, wherein the relatively soft filler material protrudes axially at least 0.3 mm beyond the metallic strip.

8. The apparatus of claim 5, wherein the relatively soft filler material protrudes axially between about 0.2 mm and less than about 1.0 mm beyond the metallic strip.

9. The apparatus of claim 5, wherein the relatively soft filler material protrudes axially between about 0.3 mm and less than about 1.0 mm beyond the metallic strip.

10. The apparatus of claim 5, wherein the relatively soft filler material protrudes axially between about 0.4 mm and about 0.8 mm beyond the metallic strip.

11. The apparatus of claim 5, wherein the spiral wound gasket comprises a gasket density of between about 1.4 w/mm and about 1.90 w/mm.

12. The apparatus of claim 5, wherein the spiral wound gasket comprises a gasket density of about 1.49 w/mm.

13. The apparatus of claim 5, wherein the spiral wound gasket comprises a gasket density of about 1.51 w/mm.

14. The apparatus of claim 5, wherein the spiral wound gasket comprises a gasket density of about 1.86 w/mm.

15. The apparatus of claim 5, further comprising an outer ring surrounding the outer circumference of the spiral sealing element.

16. The apparatus of claim 11, further comprising an inner ring within the inner perimeter of the spiral sealing element.

17. The apparatus of claim 5, wherein use of the apparatus to seal flange joints yields emissions of less than 100 ppmV of methane gas at a seating stress of less than about 50 MPa.

18. The apparatus of claim 5, wherein use of the apparatus to seal flange joints yields emissions of less than 100 ppmV of methane gas at a seating stress of less than about 100 MPa.

19. The apparatus of claim 5, wherein use of the apparatus to seal flange joints yields emissions of about 10 ppmV of methane gas at a seating stress of less than about 50 MPa.

20. The apparatus of claim 5, wherein the axial width of the metallic strip is from 4.31 mm to 4.57 mm.
